(19) United States
(12) Patent Application Publication
(10) Pub. No.: US 2005/0117772 A1
(43) Pub. Date: Jun. 2, 2005

(54) Thin type speaker having a damper

(75) Inventor: Jui-Cheng Chang, Taichung (TW)

Correspondence Address: BROWDY AND NEIMARK, P.L.L.C.;624 NINTH STREET, NW, SUITE 300, WASHINGTON, DC, 20001-5303, US

(73) Assignee: MERRY ELECTRONICS CO., LTD., Taichung (TW)

(21) Appl. No.: 10/725,022

(22) Filed: Dec. 2, 2003

(51) Int. Cl. H04R 1/00; H04R 9/06; H04R 11/02

(52) U.S. Cl. 381/404; 381/398

(57) ABSTRACT

A thin type speaker includes a casing having a top-open receiving chamber, and an electromagnet set mounted in the top-open receiving chamber and formed of a yoke, a magnet, a pole piece, and a voice coil. A vibration diaphragm is peripherally connected to the periphery of the top-open receiving chamber. The vibration diaphragm has a corrugated damper at the center thereof. The damper has a center part fixedly connected to the electromagnet set. The voice coil is disposed at one side of the vibration diaphragm facing the top-open chamber and connected to the periphery of the damper.

### BACKGROUND OF THE INVENTION

1. Field of the invention

The present invention relates to a thin type speaker and, more particularly, to a thin type speaker having a damper.

2. Description of the Related Art

A conventional dynamic speaker 90, as shown in FIG. 4, comprises a conical casing 91, a first pole piece 92 disposed at the bottom side of the casing 91, an annular magnet 93 disposed at the bottom side of the first pole piece 92, a second pole piece 94 disposed at the bottom side of the annular magnet 93, a core member 95 provided at the second pole piece 94 in the center of the annular magnet 93, an annular vibration diaphragm 96 peripherally bonded to the top edge of the inside wall of the casing 91, a voice coil 97 disposed in between the magnet 93 and the core member 95 and connected to the inner periphery of the vibration diaphragm 96 at the top thereof, an annular damper 98 of corrugated cross section disposed under the vibration diaphragm 96 with its outer diameter and inner diameter respectively connected to the casing 91 and the connection area between the voice coil 97 and the vibration diaphragm 96, and a dust-proof cap 99 provided at the center area of the outer side of the vibration diaphragm 96.

Upon input of electric current into the voice coil 97, an electromagnetic effect is produced, thereby causing the vibration diaphragm 96 and the damper 96 to vibrate with the voice coil 97 and to further produce sound. When increasing input electric current, the amplitude of the resonance of the voice coil 97 and the vibration diaphragm 96 is relatively increased. The connection of the damper 98 eliminates abnormal beatings of the voice coil 97, i.e., stabilizes the resonance of the voice coil 97 and the vibration diaphragm 96 for high power output.

However, the aforesaid design is simply employed to big scale speakers. For a thin type speaker to be used in a mobile electronic apparatus, the limited internal space can only accommodate the vibration diaphragm and the electromagnet set, and has no room for the above-mentioned installation of the damper. Therefore, conventional thin type speakers are not suitable for high power output.

### SUMMARY OF THE INVENTION

It is the primary objective of the present invention to provide a thin type speaker, which uses the limited inside space to hold a damper for high power output.

To achieve this objective of the present invention, the thin type speaker comprises a casing having a top-open receiving chamber, an electromagnet set mounted in the top-open receiving chamber, and a vibration diaphragm. The electromagnet set has a yoke, a magnet, a pole piece, and a voice coil. The vibration diaphragm is peripherally connected to the periphery of the top-open receiving chamber and has a damper at the center thereof. The damper has a corrugated cross section and a center part fixedly connected to the electromagnet set. The voice coil of the electromagnet set is provided at one side of the vibration diaphragm facing the top-open receiving chamber and is connected to the periphery of the damper.

### BRIEF DESCRIPTION OF THE DRAWINGS

FIG. 1 is a sectional view of a thin type speaker according to the first preferred embodiment of the present invention.

FIG. 2 is a sectional view of a thin type speaker according to the second preferred embodiment of the present invention.

FIG. 3 is a sectional view of a thin type speaker according to the third preferred embodiment of the present invention.

FIG. 4 is a sectional view of a thin type speaker according to the prior art.

### DETAILED DESCRIPTION OF THE PREFERRED EMBODIMENTS

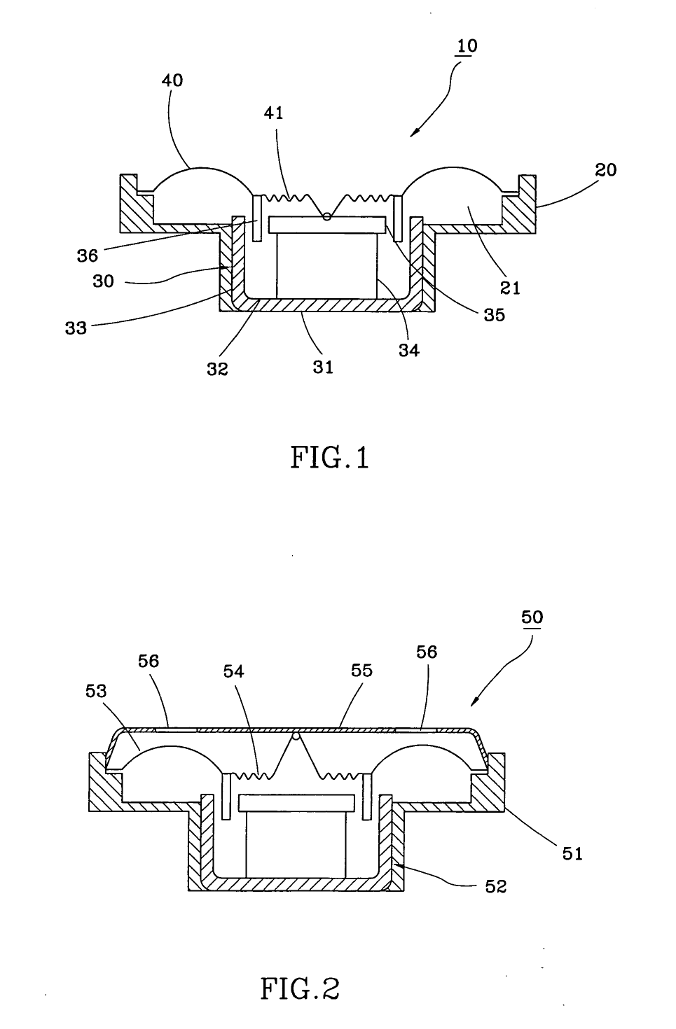

Referring to FIG. 1, a thin type speaker 10 in accordance with the first preferred embodiment of the present invention is shown comprised of a casing 20, an electromagnet set 30, and a vibration diaphragm 40.

The casing 20 has a recessed top receiving chamber 21.

The electromagnet set 30 is mounted inside the recessed top receiving chamber 21, comprising a yoke 31, a magnet 34, a pole piece 35, and a voice coil 36. The yoke 31 is mounted in the bottom side inside the recessed top receiving chamber 21, having a circular base 32, and an annular upright peripheral wall 33 upwardly extended from the border of the circular base 32. The magnet 34 is a cylindrical member disposed at the center of the top surface of the circular base 32 of the yoke 31. The pole piece 35 is bonded to the top side of the magnet 34. The voice coil 36 is provided at an inner side of the vibration diaphragm facing the top-open receiving chamber 21 and spaced between the periphery of the magnet 34 and the annular upright peripheral wall 33 of the yoke 31.

The vibration diaphragm 40 is made of flexible material, having an integrated damper 41 at the center. The damper 41 has a corrugated cross section. The periphery of the vibration diaphragm 40 is bonded to the top side of the periphery of the recessed top receiving chamber 21 of the casing 20, keeping the center of the damper 41 fixedly fastened to the top surface of the pole piece 35 of the electromagnet set 30 by adhesion (or heat sealing, or high-frequency bonding). The top side of the voice coil 36 of the electromagnet set 30 is peripherally bonded to the periphery of the damper 41.

Upon input of electric current into the electromagnet set 30, the voice coil 36 is driven to vibrate alternatively up and down, thereby causing the vibration diaphragm 40 to produce sound. Because the damper 41 is connected to the voice coil 36, it vibrates steadily following increase of input electric current, thereby eliminating abnormal beatings. Therefore, the invention uses the limited inside space to install a damper for high output.

FIG. 2 shows a thin type speaker constructed according to the second preferred embodiment of the present invention. As illustrated, the thin type speaker 50 comprises a casing 51, an electromagnet set 52 mounted inside the casing 51, a vibration diaphragm 53 peripherally connected to the top edge of the casing 51 and having an integrated damper 54 at the center, and a cap 55 covered over the top side of the casing 51. The dust cap 55 has a plurality of sound holes 56. The damper 54 of the vibration diaphragm 53 has a center area projecting vertically upwards and connected to the inner side of the cap 55.

Further, a speaker according to the present invention can be of paper cone series or general ferrite type made in a circular, rectangular, or oval shape.

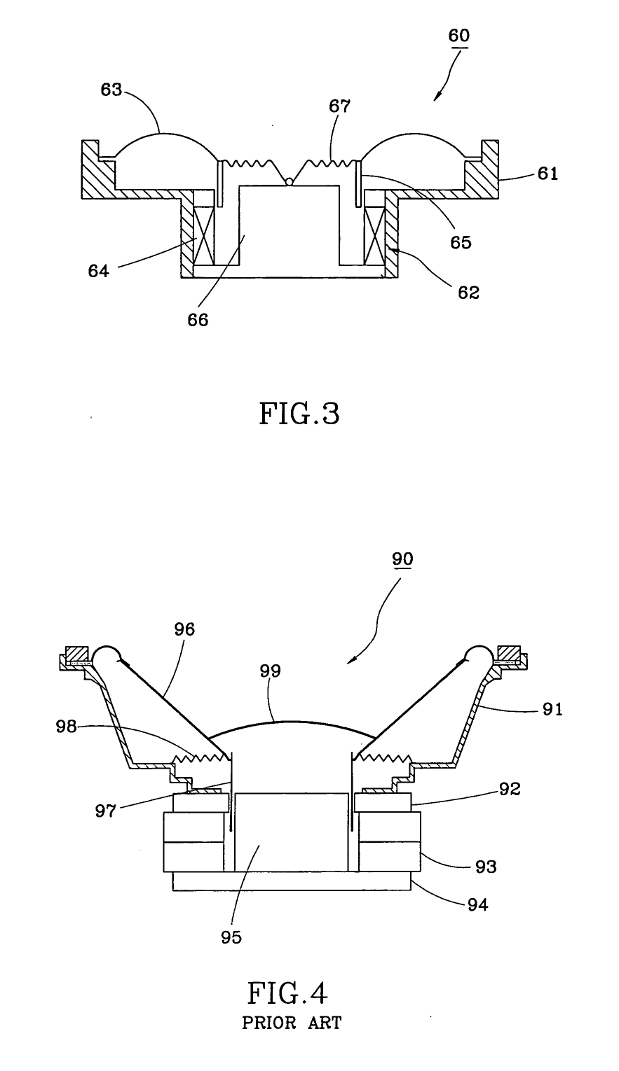

FIG. 3 shows a thin type speaker constructed according to the third preferred embodiment of the present invention. As illustrated, the thin type speaker 60 is substantially similar to the aforesaid first preferred embodiment of the present invention. According to this embodiment, the electromagnet set 62 and the vibration diaphragm 63 are mounted in the casing 61; the magnet 64 of the electromagnet set 62 is an annular member spaced around the voice coil 65; the electromagnet set 62 further comprises a core member 66 disposed inside the voice coil 65; the center of the damper 64 of the vibration diaphragm 63 is fixedly fastened to the top side of the core member 66. This arrangement achieves high power output.

In order to provide many power output choices and to facilitate fabrication, the vibration diaphragm and the damper may be separately made from different materials and then fixedly fastened together. This fabrication method achieves the aforesaid same effects.

1. A thin type speaker comprising:
a casing having a top-open receiving chamber;
an electromagnet set mounted in said top-open receiving chamber, said electromagnet set having a yoke, a magnet, a pole piece, and a voice coil; and
a vibration diaphragm peripherally connected to a periphery of said top-open receiving chamber of said casing,
wherein said vibration diaphragm has a damper at the center thereof, said damper having a corrugated cross section and a center part fixedly connected to said electromagnet set; said voice coil of said electromagnet set is provided at one side of said vibration diaphragm facing said top-open receiving chamber and said voice coil is connected to a periphery of said damper.

2. The thin type speaker as claimed in claim 1, further comprising a cap covered over a top side of said vibration diaphragm and peripherally bonded to said casing, said cap having a plurality of sound holes.

3. The thin type speaker as claimed in claim 1, wherein the center part of said damper is fixedly connected to said pole piece of said electromagnet set.

4. The thin type speaker as claimed in claim 1, wherein said electromagnet set further comprises a core member disposed inside said voice coil and the center part of said damper is fixedly connected to said core member of said electromagnet set.

5. The thin type speaker as claimed in claim 1, wherein said damper is integrally formed with said vibration diaphragm.

6. The thin type speaker as claimed in claim 1, wherein said damper and said vibration diaphragm are respectively made from different materials; said vibration diaphragm has an annular shape; said damper has an outer peripheral edge connected to an inner peripheral edge of said vibration diaphragm.

7. A thin type speaker comprising:
a casing having a top-open receiving chamber;
a cap disposed at a top side of said casing and having a plurality of sound holes;
an electromagnet set mounted inside said top-open receiving chamber, said electromagnet set having a yoke, a magnet, a pole piece, and a voice coil; and
a vibration diaphragm peripherally connected to a periphery of said top-open receiving chamber;
wherein said vibration diaphragm has a damper at the center thereof, said damper having a corrugated cross section and a center part fixedly connected to an inner side of said cap; the voice coil of said electromagnet set is disposed at one side of said vibration diaphragm facing said top-open receiving chamber and the voice coil is connected to a periphery of said damper;

8. The thin type speaker as claimed in claim 7, wherein said damper is integrally formed with said vibration diaphragm.

9. The thin type speaker as claimed in claim 7, wherein said damper and said vibration diaphragm are respectively made from different materials; said vibration diaphragm has an annular shape; said damper has an outer peripheral edge connected to an inner peripheral edge of said vibration diaphragm.
